(19) United States
(12) Patent Application Publication
(10) Pub. No.: US 2004/0194643 A1
(43) Pub. Date: Oct. 7, 2004

(54) Texture synchronizer

(76) Inventor: Prince Tikare, London (GB)

Correspondence Address: TIKAREPRINCE, SUITE 188, 8-17 TOTTENHAM CT RD, LONDON, W1T 1JY, GB

(21) Appl. No.: 10/827,760

(22) Filed: Apr. 16, 2004

(30) Foreign Application Priority Data
Apr. 4, 2003 (GB) 0307842.5
Mar. 25, 2004 (GB) 0406750.0

(51) Int. Cl. A23L 1/31

(52) U.S. Cl. 99/511

(57) ABSTRACT

A texture synchronizer having two chambers for respectively extracting a fluid and for combining fluids, the first housing a centrifugal extractor and the second housing a rotary blade, the two chambers being connected by a chute for transferring fluid to the combining chamber, the two active elements being powered jointly by an electric motor via a belt.

### BACKGROUND OF INVENTION

This invention relates to an apparatus for producing and combining food extracts of differing viscosities, adapted for domestic and commercial use and provided as a single apparatus. It is applicable to the fields of catering, entertainment and leisure.

### DESCRIPTION OF THE RELATED ART

In the past, various types of apparatus have been known, including a provision for separate devices for the extraction and combination of extracts or liquids. This is acceptable in an industrial setting however is inadequate for a domestic setting where it is increasingly expected that one domestic kitchen utility should perform one or preferably more than one function, and certainly that there should not be two devices needed for a single function. An example of where common food preparation is currently performed in the domestic setting is in the preparation of mixed fruit extract blends.

In this case it is first necessary to prepare at least one extract such as for example orange juice, usually by hand, and then necessary to mix it with another liquid or other liquids, for example banana pulp, to generate a desired consistency and texture. Furthermore, as these actions are performed independently it is normal in a non-industrial setting that a resulting extract ratio such as a juice to pulp ratio will be different to a preferred such ratio.

The currently available design solutions for part-preparation of such beverages and foodstuffs are such that the user-base of the domestic market will in general not be able to create a beverage or foodstuff to a desired consistency or texture, because of the inaccuracies inherent in dividing an extract combining process into separate stages, without considerable wastage.

These currently available design solutions also have the disadvantages that they either require a user to purchase multiple pieces of equipment, or undesirably require a user to perform parts of a food or drink preparation method separately or even by hand, or require a user to clean and maintain multiple or complicated utensil apparatus's.

### SUMMARY OF INVENTION

It is an object of the present invention to provide at least food or drink preparation apparatus of an at least desired consistence or texture.

It is a further object of the present invention to provide at least food or drink preparation apparatus of an at least desired consistence or texture able to accept and combine at least two ingredients, at least one of which may be substantially solid.

It is a yet further object of the invention to provide an at least food or drink preparation apparatus of an at least desired consistency or texture able to accept at least one substantially solid ingredient, and at least one other ingredient and able to perform extraction and mixing simultaneously at respectively controlled rates so as to enable a user to generate an at least drink or foodstuff with a desired consistency.

According to a first aspect of the present invention there is provided a texture synchronizer for providing consumables, comprising at least a first housing 1, a second housing 13, a connecting route 7, a centrifugal extractor means 3 housed in the first housing, and an at least substantially mixing or blending means 11 housed in the second housing 13, a first end of the connecting route connecting to the first housing and a second end of the connecting route connecting to the second housing 13.

According to a second aspect of the present invention there is provided a method of synchronizing texture having the steps of: centrifugally extracting a liquid from a foodstuff in a first housing 1; passing extracted liquid down a slanted base of the first housing 1 into and down a connecting route to a second housing 13; mixing or blending liquid passed down the connecting route with at least a liquid, an extract or a foodstuff present in the second housing 13 with a mixing or blending means.

### BRIEF DESCRIPTION OF DRAWINGS

For a better understanding of the invention and to show how the same may be carried into effect, reference will now be made, by way of example, to the accompanying drawings, in which:

FIG. 1 is a diagram of a texture synchronizer as seen from above according to one embodiment of the present invention;

FIG. 2 is a diagram of a texture synchronizer as seen from one side according to one embodiment of the present invention; and

FIG. 3 is a diagram of a texture synchronizer as seen from a diagonal angle according to one embodiment of the present invention.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well known features may be omitted or simplified in order not to obscure the present invention.

According to a general embodiment there is provided a texture synchronizer for providing consumables, comprising at least a first housing 1, a second housing 13, a connecting route 7, a centrifugal extractor means 3 housed in the first housing, and an at least substantially mixing or blending means 11 housed in the second housing 13, a first end of the connecting route connecting to the first housing and a second end of the connecting route connecting to the second housing 13.

According to a coupled embodiment there is provided a texture synchronizer comprising at least a first housing 1, a second housing 13, a connecting router, a centrifugal extractor means housed in the first housing 1, and an at least substantially mixing or blending means housed in the second housing 13, the first housing 1 having a slanting base terminating in a first end of the connecting route, a second end of the connecting route connecting to the second housing 13, the centrifugal extractor means and the at least substantially mixing or blending means being mechanically coupled and being jointly powered by an electric motor.

According to the coupled embodiment the mechanical coupling of the centrifugal extractor and the at least substantially mixing or blending means is substantially a pulley or belt coupling.

According to any of the embodiments the slanting base of the first housing 1 is arranged substantially higher than at least part of the second housing 13.

According to any of the embodiments the slanting base of the first housing 1 is arranged substantially proximal to or higher than a full limit level of the second housing 13.

According to any of the embodiments the connecting router may be arranged having a through-route substantially non-horizontal.

According to any of the embodiments the connecting route or the second housing 13 may be provided with a unidirectional valve arranged to permit fluid to pass from the first housing 1 to the second housing 13.

According to any of the embodiments the connecting route or the second housing 13 may be provided with a unidirectional valve arranged to permit fluid to pass from the first housing 1 to the second housing 13 only.

According to any of the embodiments the first end of the connecting route may be substantially larger than the second end thereof.

According to any of the embodiments the connecting route may be a chute the first end thereof being a posterior end, and the second end thereof being an anterior end thereof.

According to any of the embodiments the texture synchronizer has at least a base or chassis of plastic, aluminium or aluminium alloy.

According to any of the embodiments the texture synchronizer is for and adapted for use with fruit and vegetables and for an adapted for at least producing fruit beverages.

According to any of the embodiments the first and second housings are formed as one component.

According to any of the embodiments the centrifugal extractor is positioned substantially vertically above the at least mixing or blending means and both are connected directly to and powered from a single column.

According to any of the embodiments the second housing 13 has a substantially level base.

According to any of the embodiments the second housing 13 has a substantially flat base.

According to any of the embodiment the texture synchronizer may be provided with a measuring means for measuring at least one parameter. Such a measuring means for at least one parameter may be adapted to display at least one parameter. Such an at least one parameter may include at least one fluid parameter. Such an at least one fluid parameter may include any or any combination of a temperature, a volume, an acidity or pH, a viscosity, a velocity, a pressure, an electrical resistance and a resistivity. Such an at least one parameter may include at least one texture synchronizer parameter. Such an at least one texture synchronizer may include any or any combination of a temperature, an extractor rotary speed, a blender or like means rotary speed, a motor rotary speed, an extractor torque and a blender or like means torque.

According to any of the embodiments the texture synchronizer may be provided with a pH or acidity measuring means. The texture synchronizer or such means may be further adapted to display a pH or acidity on a display means and or be able to display information relating to known fluids having a detected pH. More generally in the case where other or more than one parameter is to be measured such a display may display information relating to fluids known to have parameter values comparable to measured parameters values.

According to any of the embodiments the texture synchroniser may be adapted to at least accept or sent information via a port or transmission device. Such a port may be a USB (universal serial bus) port. Whether or not the port or transmission is a USB port, it may be for accepting recipe information, it may further be for connecting to a computer to access provide information to or be controlled by a computer program or a webpage on the internet or other web based service. Such a port may be adapted to receive a data storage device for any or any combination of the above purposes. Such a data storage device may be a non-volatile solid state data storage device.

According to any of the embodiments the centrifugal extractor and the at least mixing or blending means are adapted to only operate simultaneously.

According to any of the embodiments the at least mixing or blending means comprises a blender attachment or a rotable blade 11.

According to any of the embodiments the centrifugal extractor means comprises a substantially sieve-like means provided as a member defined with a plurality of holes therein, or provided as a member defined with a plurality of slits therein.

The substantially sieve like means may alternatively be provided as a permeable membrane or a semi-permeable membrane. The substantially sieve like means is provided as having a side surface. The side surface preferably extends to substantially form an outer cylinder having a substantially central and substantially vertical axis.

There may preferably be a substantially inwardly directed lip at both the top and bottom of the substantially cylindrical side surface, or a retaining means at the top and bottom of the substantially cylindrical side surface, preferably being closed at the bottom thereof, and preferably being open or openable at the top thereof.

The centrifugal extractor is adapted to accept foodstuffs therein, to spin about an axis, to contain a portion of a foodstuff being fibrous or solid, and to expel a portion of the foodstuff being a juice or extract thereof.

According to any of the embodiments the substantially mixing or blending means may be composed of at least one blade 11 adapted to rotate about an axis. Said at least one blade 11 may preferably be of carbon fibre.

According to any of the embodiments a connecting route being a chute may be shaped to decrease in cross sectional area along the connecting route such that extract may be substantially injected into the second chamber.

According to any of the embodiments the centrifugal extractor may be provided with at least one cutting or fragmenting means at the top thereof and the first housing 1 provided with an accepting tube such that foodstuffs inserted during operation via said accepting tube will be substantially fragmented or cut up on entry to the centrifugal extractor. In this case the accepting tube will preferably be at least 10 cm long to prevent injury by insertion of a finger or fingers and will preferably be less than 6 cm wide to prevent injury by insertion of a hand.

According to any of the embodiments any of the first and second housings may be provided jointly or separately with a door, lid or cover, and the texture synchronizer is adapted such that when any such door, lid or cover is substantially open or off, power will not be provided to any provided motor.

According to any of the embodiments the texture synchronizer is adapted to operate on alternating current of at least 100 volts root mean squared.

According to any of the embodiments the texture synchronizer is adapted to operate with a power consumption of at least 300 watts, more preferably at least 500 watts, more preferably at least 700 watts, more preferably at least 900 watts, more preferably at least 1100 watts. Such a powerful device has been found to perform combined extraction and combination actions at an acceptable speed for a user.

According to any of the embodiments a motor may be provided in the texture synchroniser in a substantially central position.

According to any of the embodiments a motor may be provided connected to one of the centrifugal extractor means and the substantially mixing or blending means by a motor shaft. Preferably such a motor may be connected to the centrifugal extractor means.

According to any of the embodiments the first housing 1 may be substantially larger than the second housing 13.

According to any of the embodiments the first housing 1 may substantially have a larger diameter than the second housing 13.

As hereinabove and henceforth used; the term centrifugal is intended also to refer to and relate to centripetal.

According to any of the embodiments the second housing 13 may be provided with an outlet. Such an outlet may preferably be valve operated and preferably manually operated. Such a valve may be manually operated by a mechanical lever or button or may be provided as a pneumatically or hydraulically operated valve.

According to any of the embodiments the first housing 1 may be provided with opaque plastic sides, and the second housing 13 may be provided with substantially transparent sides.

There may be provided a texture synchronizer adapted to process various types of fruit of differing viscosities, with the result being an extracted and blended beverage or foodstuff.

An existing process operates around two stages that employ two different devices. These devices have a disadvantage of not being efficient in their use of time and energy. As an example, blending a balanced mix of orange juice and banana pulp, it would be optimal to utilise a liquid extractor and a blender within a domestic setting.

The combinatory nature of both processes in operational terms demands from the end-user a range of activities i.e. Separate preparatory efforts expended on juicing and consequently the ratio of pulp to juice: relative to texture, taste and temperature cannot be specified or regulated precisely by a user.

The choice available to the consumer for the preparation, making and consuming of the juice+pulp mix are constrained by current product design types and the applicant is not aware of any adequate process solutions.

An objective of the product is to enable a user-friendly juicing and pulping based activity, having a goal of further enabling a user to increase production efficiency and precision. This may be achieved by integrating both juicing and pulping processes into one device. User efficiency may be increased by a simultaneous centrifugal drive and processing system.

Separation in fruit processing normally occurs, through a centrifugal system. This enables the water content to be sieved from the fruit fibre within chamber A, chamber A will process fruits of low liquid viscosity.

The texture synchronizer enables synergy when the liquid fruit is channelled through a chute under free fall of gravity from chamber A, its momentum induces the entry of liquid into chamber B This activity will add to the inherent velocity within chamber B created by fruits of a higher liquid viscosity, such as banana and mango. Both chambers, A and B are driven by the same motor, each operating at a speed suited to the present fluid viscosity.

An impermeable diaphragm valve may prevent the back flow of liquid from chamber B into chamber A.

### DESCRIPTION OF THE PREFERRED EMBODIMENT

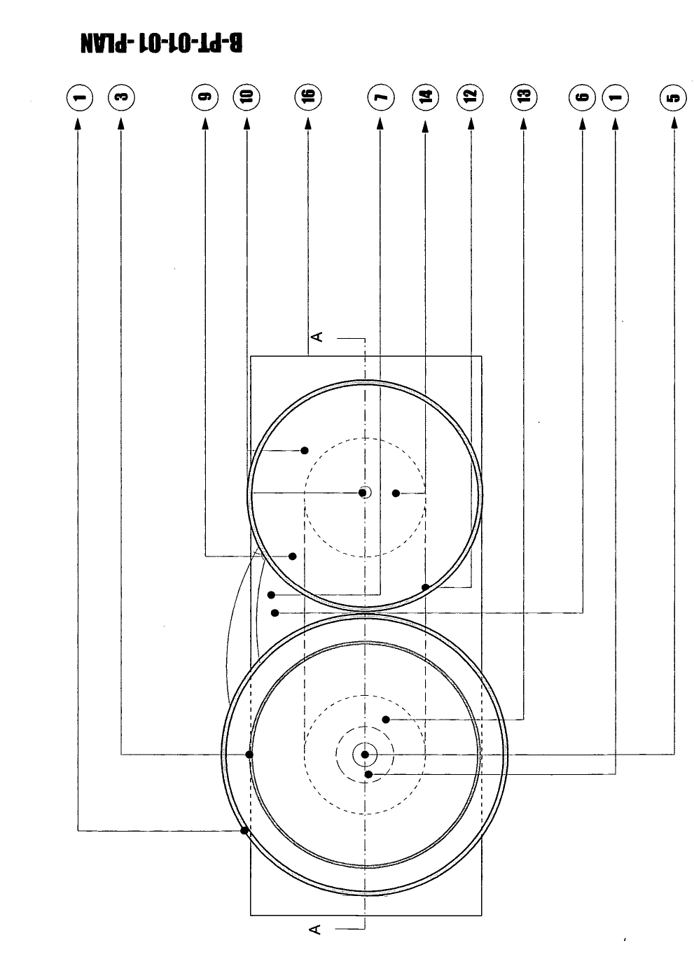

An embodiment of this invention will now be explained with reference to the drawings. This invention is for use as a texture synchronizer. Further this invention is for producing and combining food extracts of differing viscosities, adapted for domestic use and provided substantially as a single apparatus. FIG. 1 shows a texture synchronizer according to an embodiment of the present invention.

The texture synchronizer according to a preferred embodiment is provided comprising at least a first housing 1, a second housing 13, a connecting router, a centrifugal extractor means housed in the first housing 1, and an at least substantially mixing or blending means housed in the second housing 13, the first housing 1 having a slanting base terminating in a first end of the connecting route, a second end of the connecting route connecting to the second housing 13.

Said first and second housings are provided next to one another with the first housing 1 substantially higher than the second housing, the two housings being formed as a single component. The centrifugal extractor means comprises a sieve being cylindrical about an axis being a preferably vertical axis. The sieve is closed at a bottom end and open or partially openable at a top end, and is rotable about said axis. Said first housing 1 is provided so as to prevent a user's hand coming into contact with said sieve at least whilst spinning, and may be provided with a lid, the closing of which may permit the activation of the rotation of the sieve means.

Said second housing is provided to accept extract from said first housing 1 and to mix or blend said extract with any additional ingredient or fluid which may have a differing viscosity to the extract.

The substantially blending or mixing means and the centrifugal extractor are powered jointly by a single electric motor connected to a belt or pulley means such that both devices operate together. The two devices preferably have a fixed respective angular velocity relationship.

Furthermore the texture synchronizer is preferably provided such that both the first and second housings may be separately or jointly accessed by means of at least one door, lid or cover, and is preferably provided such that the power is not provided to the electric motor when any of said at least one door, lid or cover of at least said first or second housing is substantially open or off.

The sides and tops of first and second housings may be substantially of see-through plastic, whilst the bases thereof may be of opaque plastic.

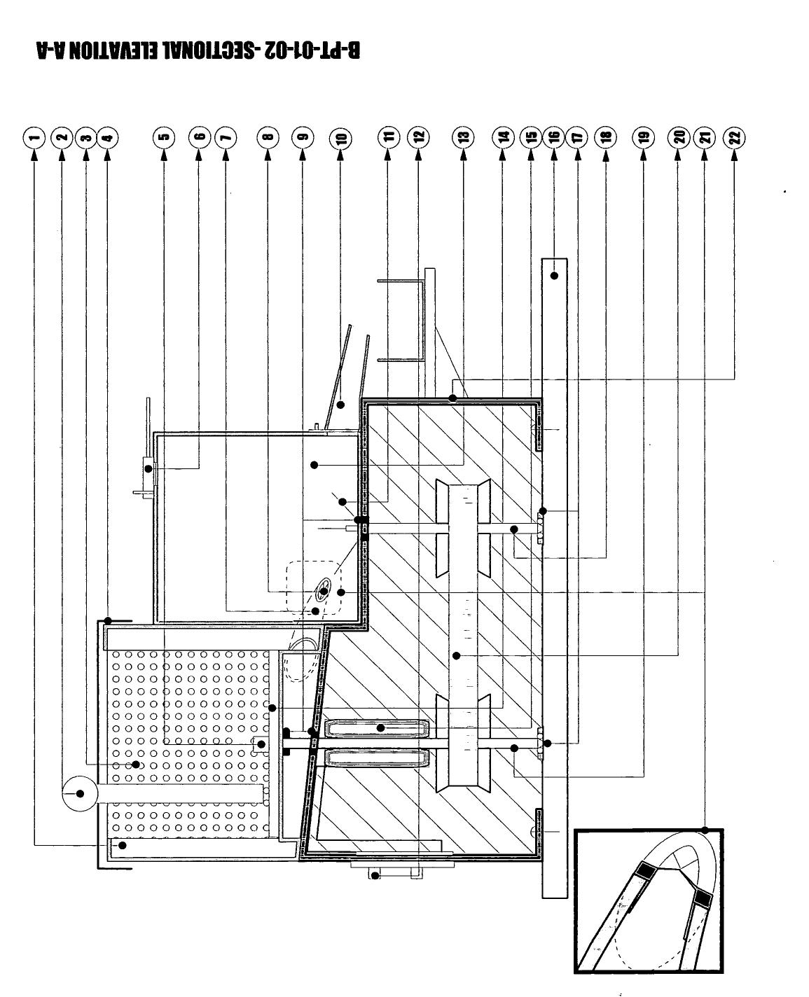

FIG. 2 shows an illustration of a texture synchronizer from a side view. A first chamber being preferably a cylindrical chamber 1 is provided preferably with a plunger device 2, preferably with a rotary extraction device 3 being preferably a cylindrical sieve chamber 3, preferably with a cover 4, preferably with a fixably attachable rotary blade preferably being or having a screw cap on rotor blade 5, and preferably with at least one fluid seal 9.

A second chamber 13 is provided preferably with an aperture thereto 6, preferably with a connecting route being preferably a duo concentric chute 7, preferably with a uni-directional flow means being preferably a uni-directional valve means, being preferably a diaphragm flap 8, preferably with an exit aperture having preferably a shutter or door device 10, and preferably with a liquid agitating means being preferably a rotary structure disintegrating means, being preferably a rotary blade means, being preferably a finger blade, and or being preferably of carbon fibre, and most preferably being a carbon fibre finger blade 11.

The texture synchronizer is preferably provided with a control panel 12 which may be connected to or more preferably comprise circuitry. Such circuitry may be adapted to control at least one function of the texture synchronizer such as preferably at least a rotary speed of at least one of the rotary extractor means 3 and the rotary blade means 11.

The texture synchronizer may preferably be provided with a drive means being preferably an electric motor 15 and may preferably be provided at least predominantly with a base unit 16. The drive means preferably is directly coupled to one of the rotary extractor 3 and the rotary blade 11 the two being coupled by a coupling means which may preferably be a drive belt 20 and may preferably each be coupled to a respective rotary shaft 18, 19 the shafts 18, 19 being coupled by the coupling means and being respectively held by respective ball bearing casings or rubber seals being preferably ball bearing casings 17.

The texture synchronizer is preferably provided with a casing being preferably a metal casing being preferably a steel casing being preferably a steel armature casing 22.

FIG. 2 also shows an enlarged view 21 of a cross section through a duo-concentric chute provided with a diaphragm flap.

1. A texture synchronizer for providing consumables, comprising at least a first housing (1), a second housing (13), a connecting route (7), a centrifugal extractor means (3) housed in the first housing (1), and an at least substantially mixing or blending means (11) housed in the second housing, a first end of the connecting route connecting to the first housing (1) and a second end of the connecting route connecting to the second housing.

2. The texture synchronizer of claim 1 wherein the centrifugal extractor means and the at least substantially mixing or blending means are jointly powered by an electric motor (15).

3. The texture synchronizer of claim 2 wherein the centrifugal extractor means (3) substantially constitutes a cylindrical sieve.

4. The texture synchronizer of claim 3 wherein the at least substantially mixing or blending means (11) comprises or is provided with a carbon fibre blade (11).

5. The texture synchronizer of claim 4 wherein said base of the first housing (1) is substantially higher than said base of the second housing (13).

6. The texture synchronizer of claim 5 provided with at least one door, lid or cover being openable or removable to permit access to at least one of the first and second housings.

7. The texture synchronizer of claim 6 for specific use in the preparation of liquid nourishment.

8. The texture synchronizer of claim 7 for specific use in the preparation of juice beverages.

9. The texture synchronizer of claim 8 being provided with at least one of a chassis or housing of at least one of plastic, aluminium and aluminium alloy.

10. The texture synchronizer of claim 9 wherein the first and second housings are formed as a single element.

11. The texture synchronizer of claim 10 wherein said connecting route comprises a chute.

12. The texture synchronizer of claim 11 wherein said chute is provided with a through route being substantially slanted downward towards said second housing.

13. The texture synchronizer of claim 11 wherein said centrifugal extractor is provided with a rotary blade or fragmenting member adapted substantially to cut or fragment any food or liquid suspension matter provided thereto whilst the centrifugal extractor is rotating.

14. A texture synchronizer of claim 1, said first housing 1 having a slanting base and said connecting route being a sloping chute.

15. A texture synchronizer of claim 14, said centrifugal extractor and said at least substantially mixing or blending means being jointly powered by a single motor.

16. A texture synchronizer of claim 15 provided with a pulley means or a belt means and a motor shaft connecting to said first housing (1).

17. A texture synchronizer of claim 16 being specifically for providing liquid nourishment.

18. A texture synchronizer of claim 17 being specifically for providing juice beverages.

19. A texture synchronizer of claim 18 wherein one of said first housing (1) and said second housing (13) is provided higher than the other.

20. A texture synchronizer of claim 19 wherein said chute is provided with a unidirectional diaphragm valve.

21. A texture synchronizer of claim 20 having a base or chassis of plastic or cast aluminium.

22. A texture synchronizer of claim 21 wherein the centrifugal extractor (3) comprises a sieve (3).

23. A texture synchronizer of claim 22 wherein the centrifugal extractor (3) comprises a sieve 3 and a rotary blade (14).

24. The texture synchronizer of claim 1 wherein said first and second housings are of plastic or cast aluminium, the connecting route being a chute, the first housing (1) having a slanting base terminating in an anterior end of said chute, the second housing (13) having a flat base and connecting to a posterior end of said chute.

25. The texture synchronizer as claimed in claim 24 wherein one of the at least two housings is provided higher than the other.

26. The texture synchronizer as claimed in claim 25 wherein the higher chamber is provided with said chute protruding therefrom a predetermined angle, said chute being at least one of either pre-formed as part of the housing, or mechanically fixed thereto, the chute having an anterior end and a posterior end the anterior end being larger than the posterior end.

27. The texture synchronizer as claimed in claim 26 having a uni-directional diaphragm-valve at the end of said chute protruding into the lower second housing.

28. The texture synchronizer as claimed in claim 27, the diaphragm being an impermeable membrane.

29. The texture synchronizer as claimed in claim 28, provided with a motor shaft connected to the centrifugal extractor means and at least a pulley system or belt system, wherein said centrifugal extractor means and said substantially mixing or blending means are jointly powered by said motor shaft connected to the centrifugal extractor means through said at least a pulley system or belt system.

30. The texture synchronizer as claimed in claim 29 wherein both said first housing (1) and said second housing (13) are adapted to be only simultaneously operated.

31. The texture synchronizer as claimed in claim 30 having a base or chassis of plastic or cast aluminium.

32. A method of producing a consumable having the steps of:
centrifugally extracting a liquid from a foodstuff in a first housing (1);
passing extracted liquid from the first housing (1) along a connecting route to a second housing;
mixing or blending liquid passed down the connecting route with at least a liquid, an extract or a foodstuff present in the second housing with a mixing or blending means.

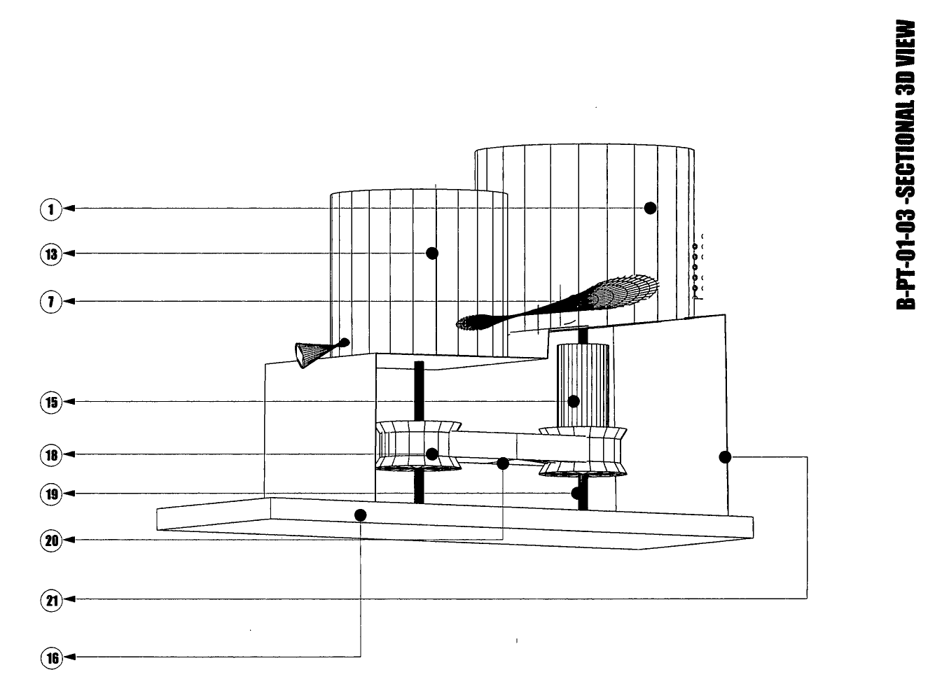

33. A texture synchronizer substantially as hereinbefore described with reference to FIGS. 1 to 3.

34. A method of synchronizing texture as hereinbefore described with reference to FIGS. 1 to 3.
